(19) United States
(12) Patent Application Publication
(10) Pub. No.: US 2023/0024477 A1
(43) Pub. Date: Jan. 26, 2023

(54) PRINTING APPARATUS, PRINTING METHOD, AND CAN BODY

(71) Applicant: Toyo Seikan Co., Ltd., Tokyo (JP)

(72) Inventors: Kenichiro YAMAMOTO, Tokyo (JP); Hisaaki MORIKAWA, Kanagawa (JP); Kouji YAMADA, Kanagawa (JP)

(21) Appl. No.: 17/956,057

(22) Filed: Sep. 29, 2022

Related U.S. Application Data
(63) Continuation of application No. PCT/JP2021/012857, filed on Mar. 26, 2021.

(30) Foreign Application Priority Data
May 7, 2020 (JP) 2020-081976

(51) Int. Cl. B41F 17/14; B41F 5/00

(52) U.S. Cl. CPC B41F 17/14; B41F 5/00

(57) ABSTRACT

A printing apparatus configured to print an image on a can body includes: a blanket transfer device configured to transfer ink on a plurality of printing plates to a blanket; and a can body transfer device configured to transfer the ink having been transferred on the blanket to the can body to print the image on the can body. The plurality of printing plates include a first printing plate and a second printing plate to print a specified image of the image. The first printing plate is configured to print a border image which is a border part of the specified image, and the second printing plate is configured to print a vicinity of the border image in the specified image.

### CROSS-REFERENCE TO RELATED APPLICATIONS

The present application is a continuation application of PCT international application No. PCT/JP2021/012857 filed on Mar. 26, 2021 which claims priority from Japanese Patent Application No. 2020-081976 filed on May 7, 2020, and the entire contents of which are hereby incorporated by reference.

### BACKGROUND

### 1. Technical Field

The present invention relates to a printing apparatus, a printing method, and a can body.

### 2. Related Art

Various images are printed on the outer circumferential surfaces of can bodies used for beverage cans. In many cases, these can bodies are offset printed in order to achieve high-speed production. In addition, in recent years, there has been known a can body whose printed part has added values providing a stereoscopic effect, a shiny effect, and a matte effect, by using special ink such as functional ink containing functional materials such as a foam material, and inorganic ink.

For example, Japanese Patent Application Laid-Open No. H09-124043 describes that foam ink containing thermal-expansible microcapsules of a forming agent is used for printing to increase the thickness of printed portions to provide the stereoscopic effect. The entire contents of the disclosure are hereby incorporated by reference.

### SUMMARY

According to the invention, a printing apparatus configured to print an image on a can body includes: a blanket transfer device configured to transfer ink on a plurality of printing plates to a blanket; and a can body transfer device configured to transfer the ink having been transferred on the blanket to the can body to print the image on the can body. The plurality of printing plates include a first printing plate and a second printing plate to print a specified image of the image. The first printing plate is configured to print a border image which is a border part of the specified image, and the second printing plate is configured to print a vicinity of the border image in the specified image.

### BRIEF DESCRIPTION OF THE DRAWINGS

FIG. 1 schematically illustrates the basic configuration of a printing apparatus according to an embodiment;

FIG. 2 is an enlarged view illustrating the vicinity of a region in which a printing plate and a blanket illustrated in FIG. 1 contact one another;

FIG. 3 is a perspective view illustrating a can body as a printed material;

FIG. 4 is a developed view illustrating a print image printed on the can body;

FIG. 5A is a partial cross-sectional view illustrating a fourth printing plate which is a resin letterpress plate;

FIG. 5B is a partial cross-sectional view illustrating a fifth printing plate which is a resin letterpress plate;

FIG. 5C is a partial cross-sectional view illustrating a sixth printing plate which is a resin letterpress plate;

FIG. 6A is a partial cross-sectional view illustrating the can body on which the print image is printed by the printing apparatus 1;

FIG. 6B is a partial cross-sectional view illustrating the can body on which the print image is printed by the printing apparatus 1;

FIG. 7 is a flowchart illustrating the printing operation of the printing apparatus to print a can body;

FIG. 8 is a block diagram illustrating functions of a plate-making system configured to manufacture printing plates attached to the printing apparatus; and

FIG. 9 is a flowchart illustrating plate-making operation to manufacture printing plates by using the plate-making system.

### DETAILED DESCRIPTION

With the conventional technique described in Japanese Patent Application Laid-Open No. H09-124043, the transferability of the foam ink is poor, and therefore the ink tends to be accumulated on blankets and non-image areas of printing plates. Consequently, the blankets and the non-image areas are easy to become dirty. Then, when the dirty blankets and printing plates are used for printing, for example, an image is likely to be greater in size than the image based on the actual image data, which is so-called “thickly printed.” This printing technique has a problem of reducing the fineness of the print image, and also reducing the productivity because the blankets and the printing plates need to be frequently cleaned.

The present invention has been achieved considering the above-described circumstances to address the above-described problems. It is therefore an aspect of the object of the invention to provide a printing apparatus and a printing method capable of printing the outer circumferential surface of a can body with added values providing a stereoscopic effect, a shiny effect, and a matte effect, while preventing a decrease in the fineness of the print image and also preventing a decrease in the productivity, and the can body thereby.

Hereinafter, an embodiment of the invention (present embodiment) will be described with reference to the drawings.

### <Basic Configuration of Printing Apparatus>

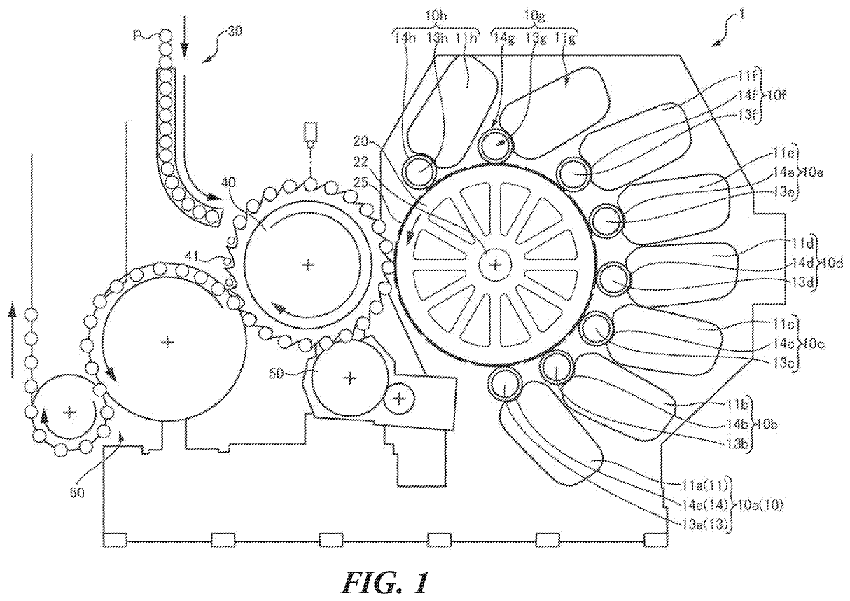

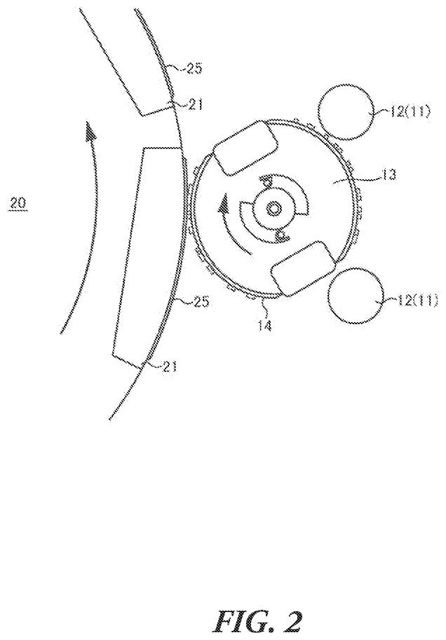

FIG. 1 schematically illustrates the basic configuration of a printing apparatus according to the present embodiment. FIG. 2 is an enlarged view illustrating the vicinity of a region in which a printing plate and a blanket illustrated in FIG. 1 contact one another.

A printing apparatus 1 illustrated in FIG. 1 is a printing apparatus for offset printing configured to print a can body (printed material) P such as a two-piece can having an approximately cylindrical shape, by transferring ink to the outer circumferential surface (outer surface) of the cylindrical part of the can body P.

As illustrated in FIG. 1, the printing apparatus 1 includes inking units 10, a blanket wheel 20, a conveyance unit 30, a mandrel wheel 40, a varnish applicator 50, and a transport unit 60.

The inking units 10 are devices configured to supply ink to printing plates 14. The inking unit 10 may be referred to as inker units. The inking units 10 are constituted by a plurality of inking units for inks in respectively different colors, that is, constituted by a first inking unit 10a to an eighth inking unit 10h. These inking units 10 are arranged along the outer circumferential surface of the blanket wheel 20. Each of the inking units 10 includes an ink supply part 11 configured to store a predetermined ink, and a plate cylinder 13 to which the printing plate 14 corresponding to the ink in the ink supply part 11 is mounted.

The plurality of ink supply parts 11 are constituted by a first ink supply part 11a to an eighth ink supply part 11h. The plurality of printing plates 14 are constituted by a first printing plate 14a to an eighth printing prate 14h to which the inks are supplied from the first ink supply part 11a to the eighth ink supply part 11h, respectively. The plate cylinders 13 are constituted by a first plate cylinder 13a to an eighth plate cylinder 13h to which the first printing plate 14a to the eighth printing plate 14h are mounted, respectively.

With the example of the printing apparatus 1 illustrated in FIG. 1, the plurality of ink supply parts 11 store basic inks in yellow (Y), magenta (M), cyan (C), and black (K), and a basic ink and a special ink in navy (N) which is a special color. To be more specific, the first ink supply part 11a stores the basic ink in yellow (Y), the second ink supply part 11b stores the basic ink in magenta (M), and the third ink supply part 11c stores the basic ink in cyan (C). The seventh ink supply part 11g stores the basic ink in black (K).

In addition, each of the fourth ink supply part 11d and the fifth ink supply part 11e stores the special ink in navy (N). The sixth ink supply part 11f stores the basic ink in navy (N).

On the other hand, the eighth ink supply part 11h does not store any ink. Therefore, the eighth printing plate 14h corresponding to the eighth ink supply part 11h is not supplied with ink.

Here, “special ink” contains functional materials and inorganic materials (referred to as “special materials”) described later. Differently from normal printing ink, this special ink not only applies colors, but also provides added values in the appearance and the touch, such as a stereoscopic effect (concave and convex, and a rough surface), a shiny effect, a matte effect, and change of colors. The special ink is used to print an inside image of a background image (specified image) described later. Meanwhile, “basic ink” means normal printing ink which does not contain those special materials, but is used only for applying colors. This basic ink is used to print images except for the inside image.

The plurality of ink supply parts 11 store the inks as described above, so that the lower the lightness of the ink is, the later the ink is supplied.

The basic ink in navy (N) is used to print border images which are the border parts in the background image (specified image) described later. Meanwhile, the special ink in navy (N) is used to print the vicinity of the border images of the background image, more specifically, the inside image inside of the border parts of the background image.

As illustrated in FIG. 2, the ink supply part 11 includes an ink roller group 12 constituted by a fountain roller, a foam roller and so forth. The ink supply part 11 supplies the ink stored in an ink repository (not illustrated) to the printing plate 14 mounted to the plate cylinder 13, by rotating the rollers of the ink roller group 12. Temperature-controlled water is circulated in part of the rollers of the ink roller group 12 to appropriately keep the temperature of the ink.

The plate cylinder 13 has an approximately cylindrical shape and can rotate around a spindle, and the printing plate 14 is detachably mounted to the outer circumferential surface of the plate cylinder 13. The plate cylinder 13 is provided such that the distance from the blanket wheel 20 can be changed. The plate cylinder 13 may be referred to as a printing cylinder.

The plurality of printing plates 14 (first printing plate 14a to eighth printing plate 14h) are manufactured by a plate-making system 200 described later, based on original image data. Each of the printing plates 14 is a resin letterpress plate including a photosensitive resin layer having image areas on which ink is put.

In the printing apparatus 1, the basic ink in yellow (Y) is supplied from the first ink supply part 11a to the first printing plate 14a; the basic ink in magenta (M) is supplied from the second ink supply part 11b to the second printing plate 14b; the basic ink in cyan (C) is supplied from the third ink supply part 11c to the third printing plate 14c; and the basic ink in black (K) is supplied from the seventh ink supply part 11g to the seventh printing plate 14g.

In addition, in the printing apparatus 1, the special ink in navy (N) is supplied from the fourth ink supply part 11d to the fourth printing plate 14d; also the special ink in navy (N) is supplied from the fifth ink supply part 11e to the fifth printing plate 14e; and the basic ink in navy (N) is supplied from the sixth ink supply part 11f to the sixth printing plate 14f.

Moreover, in the printing apparatus 1, the inks in the colors are transferred onto one blanket 25 sequentially from the corresponding first printing plate 14a to seventh printing plate 14g, respectively.

In the printing apparatus 1, after all the inks have been transferred on the same (one) blanket 25, and then the inks in all the colors on the same blanket 25 are transferred to the outer surface of the can body P at the same time, this can body P is transported from the mandrel 41 to a dryer such as an oven (not illustrated). This printing apparatus 1 can print a lot of can bodies P at high speed.

For example, an outlet configured to blow out cold air may be provided in the vicinity of the plate cylinder 13, so that the temperatures of the plate cylinder 13 and the printing plate 14 are appropriately kept.

The blanket wheel 20 is a device to rotate the blankets 25 configured to rotate to contact the printing plates 14 and the can bodies P to transfer the inks supplied to the printing plates 14 onto the can bodies P. As illustrated in FIG. 1, the blanket wheel 20 has an approximately cylindrical shape and can rotate around a spindle 22. As illustrated in FIG. 2, a plurality of segments 21 are provided on the outer circumferential surface of the blanket wheel 20 and arranged at predetermined intervals along the circumferential direction of the blanket wheel 20. The blankets 25 are mounted to the outer surfaces of the plurality of segments 21, respectively. In the printing apparatus 1 illustrated in FIG. 1, twelve blankets 25 are mounted to the segments 21.

Each of the blankets 125 is an intermediate transfer member configured to mediate the transfer of the ink from the printing plate 14 to the can body P. The blanket 25 includes a base material layer made of fabric cloth and foam, and a rubber layer made of acrylonitrile butadiene rubber. The base material layer is detachably mounted to the outer surface of the segment 21 via an adhesive material. The ink on the printing plate 14 is transferred onto the rubber layer. The rubber layer is disposed on the outer surface of the base material layer and constitutes the outer surface of the blanket 25.

In the printing apparatus 1, the blanket wheel 20 rotates in the direction of an arrow illustrated in FIG. 1 (counterclockwise), and therefore the basic ink in yellow (Y) on the first printing plate 14a, the ink basic in magenta (M) on the second printing plate 14b, the basic ink in cyan (C) on the third printing plate 14c, the special ink in navy (N) on the fourth printing plate 14d, the special ink in navy (N) on the fifth printing plate 14e, the basic ink in navy (N) on the sixth printing plate 14f, and the basic ink in black (K) on the seventh printing plate 14g are transferred, in this order, onto the same (one) blanket 25.

Here, the special ink in navy (N) is used to print a relatively wide image portion (an inside image 104f-21 of a background image 104f described later), and therefore is supplied to two printing plates, the fourth printing plate 14d and the fifth printing plate 14e.

The conveyance unit 30 is configured to convey unprinted can bodies P to the mandrel wheel 40. As illustrated in FIG. 1, the conveyance unit 30 is provided above the mandrel wheel 40. The conveyance unit 30 is provided upstream of the rotating direction of the mandrel wheel 40 from the region in which the can body P held by the mandrel 41 contacts the blanket 25. The conveyance unit 30 conveys the can bodies P one by one from above the mandrel wheel 40 to the upper part of the mandrel wheel 40 by the gravity of the can body P.

The mandrel wheel 40 is a device configured to rotate the mandrels 41 holding the can bodies P. The mandrel wheel 40 is provided next to the blanket wheel 20 in the radial direction of the blanket wheel 20. The mandrel wheel 40 has an approximately disc shape and can rotate around the spindle. A plurality of mandrels 41 are provided on the outer circumference of the mandrel wheel 40 and arranged at predetermined intervals along the circumferential direction of the mandrel wheel 40.

Each of the mandrels 41 has an approximately cylindrical shape and can be inserted into the can body P. The plurality of mandrels 41 are arranged to protrude in the direction intersecting the mandrel wheel 40, and cantilevered by the outer circumference of the mandrel wheel 40. It is preferred that the number of the mandrels 41 is an integral multiple of the number of the blankets 25. In the printing apparatus 1 illustrated in FIG. 1, twenty-four mandrels 41 are provided on the mandrel wheel 40.

The front end of the mandrel 41 absorbs the inner surface of the bottom of the can body P by air suction, and therefore the can body P is held by the mandrel 41. The posture of the mandrel 41 can be changed, and the position of the mandrel 41 also can be changed in the radial direction of the mandrel wheel 40. The mandrel 41 is provided to be able to rotate around the central axis of the mandrel 41 while holding the can body P.

The varnish applicator 50 is a device configured to overcoat the can body P to which the ink has been transferred, with finishing varnish. The varnish applicator 50 is provided next to the mandrel wheel 40 in the radial direction of the mandrel wheel 40. The varnish applicator 50 is provided downstream of the rotating direction of the mandrel wheel 40 from the contact region where the can body P held by the mandrel 41 contacts the blanket 25.

The transport unit 60 is a device configured to transport the can body P having passed through the varnish applicator 50 from the mandrel 41 to a dryer such as an oven to fix the ink and the overcoat to the can body P. The transport unit 60 is provided next to the mandrel wheel 40 in the radial direction of the mandrel wheel 40. The transport unit 60 is provided downstream of the rotating direction of the mandrel wheel 40 from the contact region where the can body P held by the mandrel 41 contacts the varnish applicator 50.

### <Can Body>

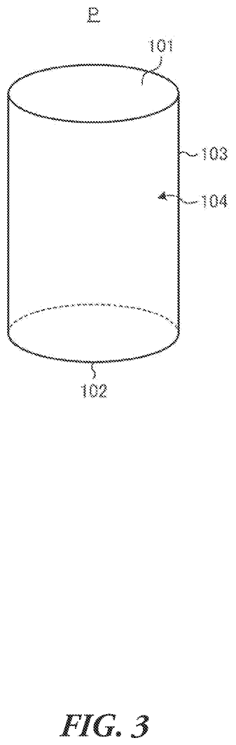

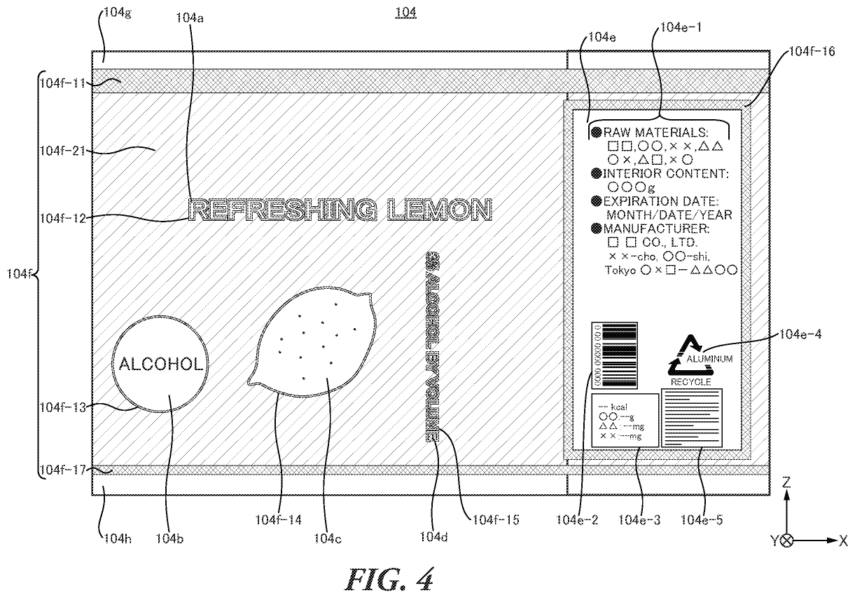

FIG. 3 is a perspective view illustrating the can body P as a printed material. The can body P such as a two-piece can has an approximately cylindrical shape, and an opening 101 is formed in the upper part of the can body P. A bottom 102 is provided in the lower part of the can body P. A print image 104, for example, with a design illustrated in FIG. 4 described later is printed on an outer circumferential surface 103 of the can body P.

This can body P is filled with drink as content from the opening 101, and the opening 101 is covered with a cover (not illustrated), and consequently becomes a canned drink product.

The drink filled in the can body P is, for example, lemon sour containing the juice and flesh of lemon and having a lemon flavor. In this case, the can body P is filled with the lemon sour, and the opening 101 is covered with the cover to provide a canned lemon sour as a drink product.

Here, the drink filled in the can body P is not limited, but may be non-alcoholic drink (for example, cold drink, fruit juice, tea, soup, non-alcoholic drink with alcohol flavors), alcohol drink (for example, beer, chuhai, sour, cocktail, sake, and wine).

The can body P may be various types of a metal can such as a seamless can and a welded can molded by drawing, drawing and ironing, and redrawing various types of a metal plate such as an aluminum plate, an aluminum alloy plate, a surface-treated steel plate such as a tin free steel, a tin plate, a chrome plated steel plate, aluminized steel plate, nickel plated steel plate, tin and nickel plated steel plate, and, other various types of an alloy-plated steel plate. A resin film such as a polyester film, a nylon film, and a polypropylene film may be laminated on the surface of the metal can.

Here, a white coating layer (white solid print layer) may be formed in advance on the outer circumferential surface 103 of the can body P.

### <Print Image>

FIG. 4 is a developed view illustrating the print image 104 printed on the can body P. As illustrated in FIG. 4, the print image 104 printed on the can body P includes a product name image 104a, an alcohol mark image 104b, a product-related image 104c, an alcohol by volume image 104d, a background image 104f (specified image) which is the background of these images, an upper end image 104g located above the background image 104f, and a lower end image 104h located below the background image 104f. By this means, the print image 104 is represented as a designed image (design image). The print image 104 also includes an information image 104e to provide detailed information of the drink product to be presented to consumers.

The product name image 104a is a relatively large logo image represented as “refreshing lemon” which is the product name of the drink product as the can body P filled with lemon sour. With the present embodiment, the product name image 104a is printed with the basic ink in magenta (M).

The alcohol mark image 104b is displayed as a logo “alcohol” within a circular frame to cause the consumers to recognize that this drink product is an alcohol drink. With the present embodiment, the alcohol mark image 104b within the circular frame is printed with the basic ink in yellow (Y), and the logo image “alcohol” is printed with the basic ink in black (K).

The product-related image 104c is an illustration image of a lemon which is a raw material of the lemon sour. Here, the product-related image 104c is not limited to this, but other images, for example, based on the impression of the lemon sour (for example, a product-dedicated mark, and a character illustration) may be possible. With the present embodiment, the product-related image 104c is printed with, for example, the basic ink in yellow (Y) and the basic ink in black (K).

The alcohol by volume image 104d is displayed as a logo “3% alcohol by volume” indicating the alcohol by volume (%) of the lemon sour. With the present embodiment, the alcohol by volume image 104d is printed with the basic ink in cyan (C).

The information image 104e indicates detailed product information of the drink product (canned fruit chuhai). This information image 104e is displayed within a rectangular frame and includes: a basic information image 104e-1 formed by character strings describing basic information such as raw materials of the content (lemon sour) filled in the can body P, the interior content, the expiration date, and the address of the manufacturer; a barcode image 104e-2; a nutrition information image 104e-3 formed by character strings describing the nutrient composition and the calorie of the interior content; a recycle mark image 104e-4 to recycle empty cans; and an instruction image 104e-5 formed by character strings describing other instructions (for example, “please drink immediately after opening the can”).

When the information image 104e includes a white coating layer (white solid print layer) formed in advance, the basic information image 104e-1, the barcode image 104e-2, the nutrition information image 104e-3, the recycle mark image 104e-4, and the instruction image 104e-5 are printed with the basic ink in black (K) within the rectangular white coating layer.

The upper end image 104g and the lower end image 104h are plane images in a color different from that of the background image 104f. These upper end image 104g and lower end image 104h are line images at the upper end and the lower end of the print image 104 to provide an accent with the basic ink in yellow (Y).

The background image 104f (specified image) is formed in a relatively wide area of the outer circumferential surface 103 of the can body P. Therefore, it is possible to enhance the value of the can body P as a drink product by the ink used to print the background image 104f.

Accordingly, the printing apparatus 1 employs special ink containing special materials such as a functional material and an inorganic material, as the ink used to print the background image 104f. By this means, the printing apparatus 1 can provide the outer circumferential surface 103 of the can body P with added values in the appearance and the touch, such as a stereoscopic effect (concave and convex, and a rough surface), a shiny effect, a matte effect and change of colors, and therefore it is possible to enhance the commercial value of the can body P.

The special ink may be at least one of functional ink containing a functional material as a special material, and inorganic ink containing an inorganic material as a special material. This special ink has a lower transferability than that of the basic ink not containing a special material, because, for example, the special material such as a functional material and an inorganic material tends to easily be removed from the ink, or because the special material has a large particle size. Therefore, the special ink supplied to the fourth printing plate 14d and the fifth printing plate 14e and transferred onto the blankets 25 tends to be accumulated on the blanket 25, and also accumulated on the non-image areas without ink, and consequently the blankets 25 and the non-image areas tend to easily become dirty.

Then, when the dirty blankets 25 and the dirty fourth printing plate 14d and fifth printing plate 14e are used for printing, the print image 104 printed on the outer circumferential surface 103 of the can body 103 is likely to be greater in size than the image based on the actual image size, which is so-called “thickly printed.”

Even though “thickly printed” due to the special ink occurs, in order to print the background image 104f in a size based on the actual image data, the printing apparatus 1 prints the background image 104f as follows. The background image 104f may be a plane image in navy (N) which is, for example, the image color of the drink product.

The printing apparatus 1 prints the border images (first border image 104f-11 to seventh border image 104f-17) which are border parts with the images adjacent to the background image 104f within the range of the background image 104f, with the basic ink in navy (N) not containing a special material. Then, the printing apparatus 1 prints the inside image 104f-21 inside of the border images in the background image 104f with the special ink in navy (N) containing a special material.

The first border image 104f-11 (with the basic ink in navy (N)) is a border part with the upper end image 104g (with the ink in yellow (Y)) within the range of the background image 104f. The first border image 104f-11 and the upper end image 104g are printed on a part, which is the neck of the outer circumferential surface 103 of the can body P. The printing apparatus 1 transfers the basic ink onto the blankets 25 not to form a print layer with the special ink on the neck of the outer circumferential surface 103 of the can body P. That is, the first border image 104f-11 is printed not with the special ink in navy (N) but with the basic ink in navy (N).

The second border image 104f-12 (with the basic ink in navy (N)) is a border part with the product name image 104a which is a logo image indicating the product name “refreshing lemon” within the range of the background image 104f.

The third border image 104f-13 (with the basic ink in navy (N)) is a border part with the circular portion (with the basic ink in yellow (Y)) of the alcohol mark image 104b within the range of the background image 104f.

The fourth border image 104f-14 (with the basic ink in navy (N)) is a border part with the product-related image 104c (with the basic ink in yellow (Y)) which is an illustration image of a lemon within the range of the background image 104f.

The fifth border image 104f-15 (with the basic ink in navy (N)) is a border part with the alcohol by volume image 104d (with the ink in cyan (C)) which is a logo image describing “3% alcohol by volume” within the background image 104f.

The sixth border image 104f-16 (with the basic ink in navy (N)) is a border part with the rectangular box (white coating layer (with the basic ink in white (W))) of the information image 104e within the range of the background image 104f.

The seventh border image 104f-17 (with the basic ink in navy (N)) is a border part with the lower end image 104h (with the basic ink in yellow (Y)) within the range of the background image 104f.

The inside image 104f-21 (with the special ink in navy (N)) is located inside of the first border image 104f-11 to the seventh border image 104f-17 within the range of the background image 104f.

With the printing apparatus 1, the printed part with the special ink in navy (N) is a part except for the border parts with the images adjacent to the background image 104f within the range of the background image 104f. In addition, the printing apparatus 1 prints the border parts within the range of the background image 104f with the basic ink in navy (N) which is the same color as that of the special ink. By this means, even though the special ink causes “thickly printed”, it is possible to keep the image to be printed in the size based on the actual image data. In addition, it is possible to provide the background image 104f with added values such as a stereoscopic effect (concave and convex, and a rough surface), a shiny effect, a matte effect, and change of colors while keeping the print size.

### <Resin Letterpress Plate>

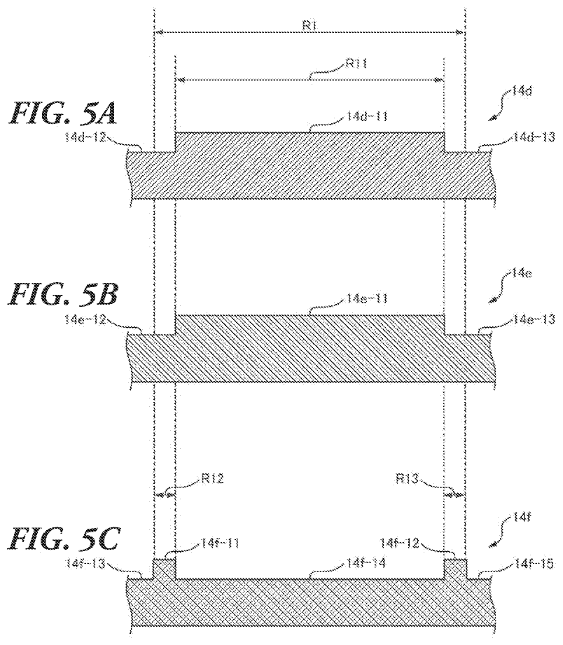

FIG. 5 is a partial cross-sectional view illustrating printing plates which are resin letterpress plates. FIG. 5(a) is a partial cross-sectional view illustrating the fourth printing plate 14d, FIG. 5(b) is a partial cross-sectional view illustrating the fifth printing plate 14e, and FIG. 5(c) is a partial cross-sectional view illustrating the sixth printing plate 14f.

The fourth printing plate 14d illustrated in FIG. 5(a) includes an image area 14d-11 on which the special ink in navy (N) is put, and non-image areas 14d-12 and 14d-13 on which ink is not put. Likewise, the fifth printing plate 14e illustrated in FIG. 5(b) includes an image area 14e-11 on which the special ink in navy (N) is put, and non-image areas 14e-12 and 14e-13 on which ink is not put. The sixth printing plate 14f illustrated in FIG. 5(c) includes image areas 14f-11 and 14f-12 on which the basic ink in navy (N) is put, and non-image areas 14f-13 to 14f-15 on which ink is not put.

The image area 14d-11 of the fourth printing plate 14d (and the image area 14e-11 of the fifth printing plate 14e), and the image areas 14f-11 and 14f-12 of the sixth printing plate 14f constitute a background image forming region R1 to form the background image 104f.

An inside image forming region R11 of the background image forming region R1 is a region to form the inside image 104f-21 illustrated in FIG. 4 with the special ink in navy (N) on the image area 14d-11 of the fourth printing plate 14d and the image area 14e-11 of the fifth printing plate 14e.

Border image forming regions R12 and R13 of the background image forming region R1 are regions to form the border images (for example, the third border image 104f-13 and the fourth border image 104f-14 in FIG. 4) with the basic ink in navy (N) on the image areas 14f-11 and 14f-12 of the sixth printing plate 14f.

The printing apparatus 1 prints the inside image with the special ink in navy (N) inside of the border images with the basic ink in navy (N) by using the fourth printing plate 14d to the sixth printing plate 14f. By this means, even though “thickly printed” due to the special ink occurs, it is possible to print the background image 104f on the can body P, with added values providing a stereoscopic effect (concave and convex, and a rough surface), a shiny effect, a matte effect, and change of colors by the special ink.

### <Special Ink>

Next, the special ink used to print the inside image 104f-21 of the background image 104f will be described. As described below, the special ink may be at least one of functional ink containing a functional material and inorganic ink.

### (1. Functional Ink)

Examples of the functional ink of the special ink include microcapsule-containing functional ink which contains various kinds of special materials encapsulated into microcapsules as functional materials, and other functional ink. In addition, the functional ink may additionally contain other materials (for example, a functional filler).

### (1-1. Microcapsule-Containing Functional Ink)

Examples of the microcapsule-containing functional ink may include foam ink, temperature-indicating ink, and photochromic ink described below.

### (1-1-1. Foam Ink)

The foam ink containing a foaming agent as a functional material is obtained by blending and dispersing a predetermined amount of the foaming agent in normal printing ink (basic ink). The foaming agent is formed as, for example, thermal-expansible microcapsules. An example of this foaming agent of thermal-expansible microcapsules may be obtained by coating a volatile solvent such as isobutene, hexane, and heptane with shell walls of copolymers of vinylidene chloride and acrylonitrile as thermoplastic resin. In this case, the temperature to soften the shell walls may be, for example, from 100 to 200 degrees Celsius.

### (1-1-2. Temperature-Indicating Ink)

The temperature-indicating ink changes in color at a specific temperature, and includes irreversible temperature-indicating ink whose color is not recovered by cooling, and reversible temperature-indicating ink whose color is recovered by cooling. This temperature-indicating ink contains components whose color is changed depending on the temperature, and the components are encapsulated into microcapsules as the functional material.

An example of the reversible temperature-indicating ink may be obtained by adding a vehicle to pigments made of iodides of heavy metals such as Hg, Ag, Cu, and Pb or complex salts thereof. For example, the reversible temperature-indicating ink having a pigment composition of Ag₂HgI₄ is changed in color at 50 degrees Celsius, and the reversible temperature-indicating ink having a pigment composition of Cu₂HgI₄ is changed in color at 70 degrees Celsius. Here, by adopting binary mixture system, it is possible to set the temperature in a range from 40 to 70 degrees Celsius. Meanwhile, an example of other reversible temperature-indicating ink may contain, as a material, cobalt chloride solution whose color is pink at room temperature and is changed to blue at a high temperature about 80 degrees Celsius.

The materials contained in the irreversible temperature-indicating ink is not limited, but may be, for example, 3(NH₄)₂O.Fe₂O₃.12MoO₃.19H₂O, Co(AsO₄)₂(Pyr)₂.10H₂O, (NH₄)₃H₆[Fe(MoO₄)₆].7H₂O, CoSiF₆, Co(C₆H₅O₇)₂, [Cu(Pyr)₂](CNS)₂, (NH₄)₃VO₃, CoNH₄PO₄.H₂O, Cu(OH)₂, [Co(NH₃)₅Cl]Cl₂, 3(NH₄)₂O.Al₂O₃.12MoO₃.19H₂O, (NH₄)₂U₂O₇, [Cr(NH₃)₅Cl]SiF₆, [Co(NH₃)₆]H.P₂O₇, and CdCO₃, NH₄MnP₂O₇.

### (1-1-3. Photochromic Ink)

The photochromic ink contains, as a functional material, microcapsules of photochromic compounds (pigments) which are colorless in an inactivated state, but develop color when being irradiated with ultraviolet light. This photochromic ink has a function to exhibit different colors, such as red, blue, purple, and yellow, depending on the quantity of the irradiated ultraviolet light.

Examples of the photochromic compound may include a spirooxazine derivative, a spiropyran derivative, and a naphthopyran derivative, and a diarylethene photochromic compound, which are changed in color with high sensitivity even when blue light is applied.

### (1-2. Other Functional Ink)

Examples of other functional ink may include fluorescent ink, and varnish repellent ink described below.

### (1-2-1. Fluorescent Ink)

The fluorescent ink may contain fluorescent pigments (particles) as a functional material. As an example of the fluorescent pigments, ultraviolet fluorescent pigments are possible. An example of the ultraviolet fluorescent pigments may be obtained by evenly dissolving dyes such as fluorescein, eosin, rhodamine 6G, rhodamine B, and basic yellow HG in resin such as polyvinyl chloride resin, alkyd resin, polymethacrylate ester resin, urea resin, and melamine resin, and powdering that.

### (1-2-2. Varnish Repellent Ink)

The vanish repellent ink contains a functional material having a property to repel resin for forming the overcoat layer such as finishing varnish as described above. The functional material may be a material forming a film having a surface tension to the extent of repelling resin such as varnish, and examples of the functional material may include silicon, fluorine, polyethylene, and polytetrafluoroethylene (PTFE).

### (1-2-3. Functional Filler-Containing Ink)

The functional filler-containing ink is not limited as long as it contains a functional filler as a functional material, and examples of the functional filler-containing ink may include organic fibers such as carbon fibers, and carbon black. This functional filler-containing ink may be obtained by further adding a functional filler to the above-described foam ink, temperature-indicating ink, photochromic ink, fluorescent ink, and varnish repellent ink.

### (2. Inorganic Ink)

Among the special ink, the inorganic ink contains various inorganic materials as special materials. In addition, the inorganic ink may further contain other materials (for example, an inorganic filler).

### (2-1. Pearl Pigment Ink)

Pearl ink contains pearl pigments as an inorganic material, and its color varies depending on the viewing angle. An example of the pearl ink may be obtained by dispersing, in transparent vehicle, pigments formed by lamination of mica, silica, or alumina having a low refractive index with metal oxide such as silicon oxide, titanium oxide, tin oxide, and iron oxide having a high refractive index. The print layer printed with the pearl ink repeatedly reflects incident light on the border between the layers having different refractive indexes, and the reflected light rays interfere with each other, so that interference colors and rainbow high coloring specific to pearl, and gloss are reproduced.

### (2-2. Aluminum Pigment Ink (Silver Ink)

Aluminum pigment ink (silver ink) is not limited, but an example of the aluminum pigment ink may be obtained by dispersing aluminum particles as an inorganic material in vehicle to represent silver color by the gloss (luminance) of the aluminum particles.

### (2-2. Gold Ink)

Gold ink is not limited, but an example of the gold ink may be obtained by dispersing brass particles (alloy of copper and zinc) as an inorganic material in vehicle to produce a metallic luster like gold, or by dispersing aluminum particles as an inorganic material in transparent yellow pigments to represent gold color by the gloss (luminance) of the aluminum particles in the transparent yellow pigments.

### (2-3. Inorganic Filler-Containing Ink)

Inorganic filler-containing ink is not limited as long as it contains an inorganic filler as an inorganic material, such as glass fibers and inorganic silica particles, and an example of the inorganic filler-containing ink may be obtained by further adding an inorganic filler to the above-described pearl pigment ink, aluminum pigment ink (silver ink), and gold ink.

### <Printed Can>

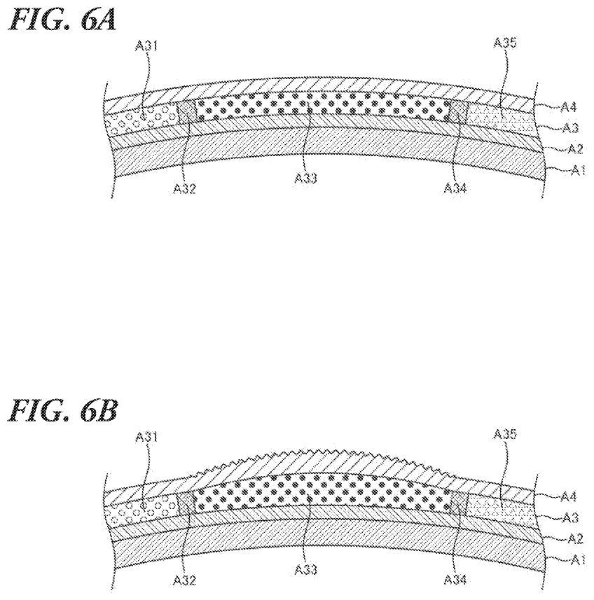

FIGS. 6(a) and (b) are partial cross-sectional views illustrating the can body P (printed can) on which the print image 104 is printed by the printing apparatus 1. With the example illustrated in FIG. 6, a white coating layer (white solid print layer) A2 is formed in advance on the outer circumferential surface of a cylindrical part A1 of the can body P, and a print layer A3 of the print image 104 is formed on the white coating layer A2. However, this is by no means limiting, but the print layer A3 of the print image 104 may be formed directly on the outer circumferential surface of the cylindrical part A1 of the can body P.

As illustrated in FIG. 6(a), the print layer A3 including a first print layer A31 to a fifth print layer A35 is formed on the white coating layer A2 formed on the cylindrical part A1.

The first print layer A31 is a print layer with the basic ink in yellow (Y) to print the alcohol mark image 104b illustrated in FIG. 4. The second print layer A32 is a print layer with the basic ink in navy (N) to print the third border image 104f-13 which is a border part with the alcohol mark image 104b in the background image 104f.

The third print layer A33 is a print layer with the special ink in navy (N) to print the inside image 104f-21 of the background image 104f. The fourth print layer A34 is a print layer with the basic ink in navy (N) to print the fourth border image 104f-14 which is a border part with the product-related image 104c of the background image 104f. The fifth print layer A35 is a print layer with the basic ink in yellow (Y) to print the product-related image 104c.

An overcoat layer A4 such as finishing varnish is formed on the print layer A3. The can body P having this overcoat layer A4 is then subjected to a baking process in a dryer such as an oven. This overcoat layer A4 may be made of varnish which is conventionally well-known transparent resin. It is preferred that this transparent resin is transparent thermosetting resin containing a lubricant. An example of the transparent thermosetting resin containing a lubricant may be obtained by adding amino resin such as melamine resin, or phenol resin, as a curing agent to base resin such as polyester resin, polyacrylic resin, and epoxy resin, and further blending a lubricant such as paraffin, polyethylene, and silicon.

With the example illustrated in FIG. 6, the special ink in navy (N) on the third print layer A33 is foam ink. This foam ink together with the finishing varnish layer A4 is heated and baked with an oven. By the heating, the volatile solvent in the shell walls of the thermal-expansible microcapsules is vaporized and thermally expanded, and therefore to thermally expand the thermal-expansible microcapsules. By this means, the third print layer A33 foams as illustrated in FIG. 6(b).

With the heating and baking process, the solvent in the overcoat layer A4 is removed as the third print layer A3 foams, so that the overcoat layer A4 is dried and cured. The overcoat layer A4 deformed by the foaming of the third print layer A33 is cured, and therefore the surface of the overcoat layer A4 gets rough as illustrated in FIG. 6(b). In this way, the print image 104 printed on the can body P by the printing apparatus 1 is finished such that the part of the background image 104f which is a relatively wide area provides a stereoscopic effect (concave and convex, and a rough surface).

### <Printing Operation of Printing Apparatus>

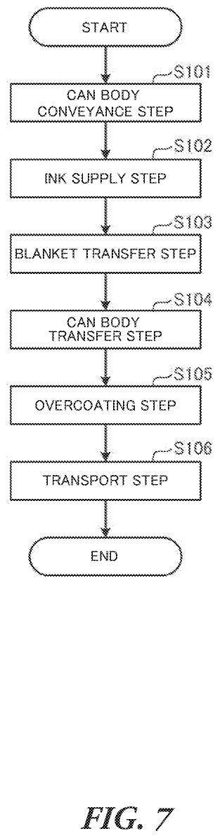

FIG. 7 is a flowchart illustrating the printing operation of the printing apparatus 1 on the can body P.

### (Step S101: Can Body Conveyance Step)

In step S101 as a can body conveyance step, the printing apparatus 1 conveys the can body P to the upper part of the mandrel wheel 40 by the conveyance unit 30. The printing apparatus 1 holds the can body P conveyed to the upper part of the mandrel wheel 40 by the mandrel 41. Before the can body P contacts the blanket 25, the printing apparatus 1 rotates the mandrel 41 to pre-spin the can body P, and then rotates the mandrel wheel 40 to move the can body P to the contact region where the can body P contacts the blanket 25. That is, the can body P rotates about its axis by the rotation of the mandrel 41, and revolves about the mandrel wheel 40 by the rotation of the mandrel wheel 40.

### (Step S102: Ink Supply Step)

In step S102 as an ink supply step following the step S101, the printing apparatus 1 rotates the ink roller group 12 of each of the plurality of ink supply parts 11 to supply the inks stored in the ink supply parts 11 to the printing plates 14 mounted to the plate cylinders 13.

In this step S102, the printing apparatus 1 supplies the basic ink in yellow (Y) from the first ink supply part 11a to the first printing plate 14a, supplies the basic ink in magenta (M) from the second ink supply part 11b to the second printing plate 14b, and supplies the basic ink in cyan (C) from the third ink supply part 11c to the third printing plate 14c. In addition, in the step S102, the printing apparatus 1 supplies the special ink in navy (N) from the fourth ink supply part 11d to the fourth printing plate 14d, supplies also the special ink in navy (N) from the fifth ink supply part 11e to the fifth printing plate 14e, supplies the basic ink in navy (N) from the sixth ink supply part 11f to the sixth printing plate 14f, and supplies the basic ink in black (K) from the seventh ink supply part 11g to the seventh printing plate 14g.

By the rotation of the plate cylinders 13, the printing plates 14 to which inks have been supplied are moved to the contact regions where the printing plates 14 contact the blankets 25, respectively.

### (Step S103: Blanket Transfer Step)

In step S103 as a blanket transfer step following the step S102, the printing apparatus 1 rotates the blanket wheel 20 to contact the printing plates 14 to which inks have been supplied, with the blankets 25, so that the inks on the printing plates 14 are transferred to the blankets 25.

In this step S103, the printing apparatus 1 transfers the basic ink in yellow (Y) on the first printing plate 14a; the basic ink in magenta (M) on the second printing plate 14b; the basic ink in cyan (C) on the third printing plate 14c; the special ink in navy (N) on the fourth printing plate 14d; the special ink in navy (N) on the fifth printing plate 14e; the basic ink in navy (N) on the sixth printing plate 14f; and the basic ink in black (Y) on the seventh printing plate 14g to one blanket 25 in this order. By this means, the image having patterns formed in the printing plates 14 is transferred to the blanket 25.

### (Step S104: Can Body Transfer Step)

In step S104 as a can body transfer step following the step S103, the printing apparatus 1 rotates the blanket wheel 20 to move the blanket 25 to which the ink has been transferred to the contact region where the can body P contacts the blanket 25. Then, the printing apparatus 1 presses the can body P held by the mandrel 41 to allow contact between the can body P and the blanket 25 having been moved to the contact region, and therefore to transfer the ink on the blanket 25 to the can body P. By this means, the image having the patterns formed in the printing plates 14 is transferred to the outer circumferential surface of the can body P via the blanket 25.

### (Step S105: Overcoating Step)

In step S105 as an overcoating step following the step S104, the printing apparatus 1 rotates the mandrel wheel 40 to move the can body P to which the ink has been transferred to the varnish applicator 50, and further to move the can body P to the transport unit 60. Then, the printing apparatus 1 actuates the varnish applicator 50 to overcoat the can body P to which the ink has been transferred, with finishing varnish.

### (Step S106: Transport Step)

In step S106 as a transport step following the step S105, the printing apparatus 1 actuates the transport unit 60 to transport the can body P having passed through the varnish applicator 50 from the mandrel 41 to a dryer such as an oven (not illustrated).

Here, the printing apparatus 1 rotates the plate cylinders 13, the blanket wheel 20, the mandrels 41 and the mandrel wheel 40 in synchronization with each other. In addition, the printing apparatus 1 actuates the varnish applicator 50 and the transport unit 60 in synchronization with the rotations of the plate cylinders 13, the blanket wheel 20, the mandrels 41 and the mandrel wheel 40. In this way, the printing apparatus 1 prints the can body P.

### <Configuration of Plate-Making System>

Next, a plate-making system 200 configured to manufacture the printing plates 14 attached to the printing apparatus 1 will be described. The plate-making system 200 adopts DTP (Desk Top Publishing) and CTP (Computer To Plate). The plate-making system 200 manufactures the printing plates 14 which are resin letterpress plates described above.

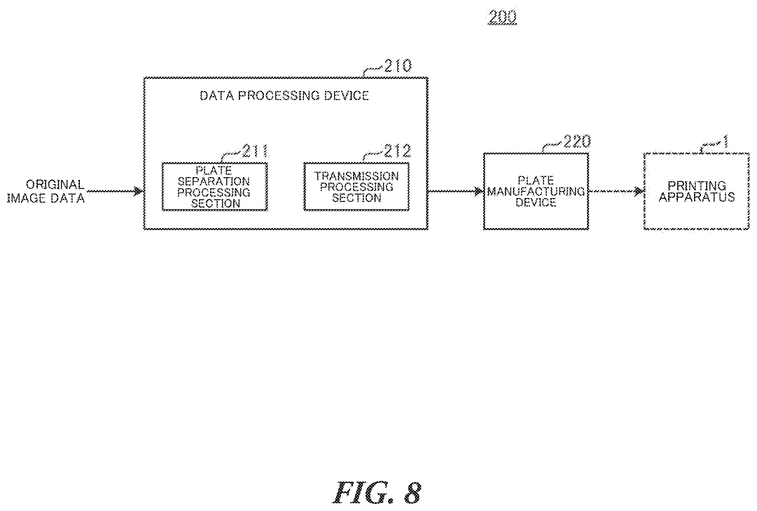

FIG. 8 is a block diagram illustrating the functions of the plate-making system 200 configured to manufacture the printing plates 14 attached to the printing apparatus 1. It is preferred that the plate-making system 200 illustrated in FIG. 8 is a system configured to manufacture the printing plates 14 by DLE (Direct Laser Engraving) method in which resin is sublimated by the heat of the laser and engraved, or LAMS (Laser Ablation Masking System) method in which an image is written to the surface of a resin plate by using the laser and is developed.

The plate-making system 200 includes a data processing device 210 configured to create plate-making image data by applying various image processing to original image data, and a plate manufacturing device 220 configured to manufacture printing plates based on the plate-making image data.

The data processing device 210 is configured to edit, for example, modify the layout and the color tone of the original image data described by the page-description language. Then, the data processing device 210 creates the plate-making image data by performing plate separation processing such as the color separation of process colors, and transmits the image data to the plate manufacturing device 220. The data processing device 210 includes a processor, a memory, and a program implementing the function of the data processing device 210.

The data processing device 210 includes a plate separation processing section 211 configured to perform plate separation processing, and a transmission processing section 212 configured to perform transmission processing to transmit data to the plate manufacturing device 220.

The plate separation processing section 211 separates the colors of the edited original image data into each of the process colors, and applies UCR (under color removal) to reproduce achromatic colors in portions in which colors overlap each other. The plate separation processing section 211 creates plate separation image data composed of the image data for each of the basic inks in yellow (Y), magenta (M), cyan (C), and black (K) extracted by the color separation, the image data for the basic ink in navy (N) as a special color, and the image data for the special ink in navy (N).

The transmission processing section 212 performs processing to transmit the plate separation image data created by the plate separation processing section 211 to the plate manufacturing device 220 as plate-making image data.

The plate manufacturing device 220 manufactures a printing plate 14 corresponding to each of the inks based on the plate separation image data transmitted from the transmission processing section 212 of the data processing device 210. That is, the plate manufacturing device 220 forms image areas on a photosensitive resin layer by, for example, photo-curing with ultraviolet irradiation, and then forms non-image areas by removing uncured portions by development, and therefore to manufacture a resin letterpress plate as the printing plate 14. The printing plates 14 manufactured by the plate manufacturing device 220 are applicable to the printing apparatus 1.

### <Plate-Making Operation by Plate-Making System>

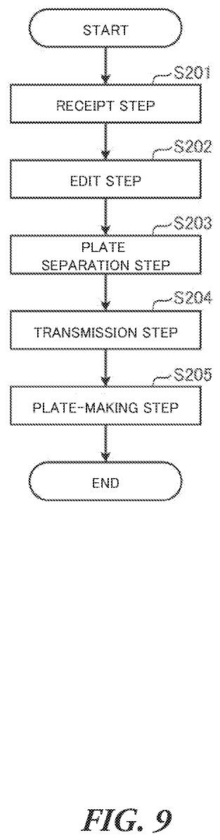

FIG. 9 is a flowchart illustrating plate-making operation to manufacture the printing plates 14 by using the plate-making system 200.

Step S201 to step S204 illustrated in FIG. 9 are performed by the data processing device 210, based on operation commands inputted by a user via a user interface provided in the data processing device 210. Step S205 is performed by the plate manufacturing device 220.

### (Step S201: Receipt Step)

In the step S201 as a receipt step, the plate-making system 200 receives original image data by the data processing device 210.

### (Step S202: Edit Step)

In step S202 as an edit step following the step S201, the plate-making system 200 edits the received original image data by the data processing device 210. The plate-making system 200 corrects the layout to match the printing area of a printed material, and modifies the color tone to edit the original image data.

### (Step S203: Plate Separation Step)

In step S203 as a plate separation step following the step S202, the plate-making system 200 causes the data processing device 210 to apply plate separation processing to the edited original image data. The plate-making system 200 separates the colors of the edited original image data into each of the process colors, and creates the plate separation image data for each of the basic inks in yellow (Y), magenta (M), cyan (C), and black (K) as the process colors, the basic ink in navy (N) as the special color, and the special ink in navy (N).

### (Step S204: Transmission Step)

In step S204 as a transmission step following the step S203, the plate-making system 200 performs transmission processing to transmit the plate separation image data created in the step S203 from the data processing device 210 to the plate manufacturing device 220 as the plate-making image data.

### (Step S205: Plate-Making Step)

In step S205 as a plate-making step following the step S204, the plate-making system 200 manufactures the printing plates 14, based on the image data transmitted by the transmission processing. The plate-making processing illustrated in FIG. 9 ends at this step 5.

### <Modification>

The above-described embodiments including a modification may apply their features to each other. The above-described embodiments are not intended to limit the subject matter of the invention but may be modified to the extent not to depart from the scope of the claims.

For example, with the above-described embodiment, the process colors are four colors, yellow (Y), magenta (M), cyan (C), and black (K). However, the process colors may be five colors by adding one of red (R), green (G), and blue (B) to those four colors.

With the above-described embodiment, the print image 104 illustrated in FIG. 4 is printed such that the inside image of the background image 104f is printed with the special ink in navy (N) and the border images bordering on the inside image are printed in the basic ink in navy (N). However, the print image printed on the outer surface of the can body P is not limited to the print image 104 illustrated in FIG. 4.

The print image printed on the outer surface of the can body P is not limited as long as the print image includes an inside image printed with an ink in any color, and bordering images printed with the ink in the same color as that of the inside image to border the inside image. For example, in the print image 104 illustrated in FIG. 4, the product name image 104a “refreshing lemon” may be an inside image, and the second border image 104f-12 bordering the inside image may be a bordering image. In addition, the inside image may be printed with the above-described special ink, and the bordering image may be printed with the above-described basic ink.

Moreover, with the above-described embodiment, the printing plate is a resin letterpress plate, but this is by no means limiting. For example, the printing plate 14 may be a waterless planographic plate including image areas on which ink is put, and non-image areas on which ink is not put without water.

According to the invention, it is possible to provide a printing apparatus and a printing method capable of printing the outer circumferential surface of a can body with added values providing a stereoscopic effect, a shiny effect, and a matte effect, while preventing a decrease in the fineness of the print image and also preventing a decrease in the productivity, and the can body thereby.

1. A printing apparatus configured to print an image on a can body, comprising:
a blanket transfer device configured to transfer ink on a plurality of printing plates to a blanket; and
a can body transfer device configured to transfer the ink having been transferred on the blanket to the can body to print the image on the can body, wherein:
the plurality of printing plates include a first printing plate and a second printing plate to print a specified image of the image;
the first printing plate is configured to print a border image which is a border part of the specified image; and
the second printing plate is configured to print a vicinity of the border image in the specified image.

2. The printing apparatus according to claim 1, wherein:
the second printing plate is supplied with a special ink which is at least one of a functional ink containing a functional material and an inorganic ink; and
the first printing plate is supplied with a basic ink which is different from the special ink.

3. The printing apparatus according to claim 1, wherein the first printing plate is configured to print the border image on the border part of the specified image within a range of the specified image.

4. The printing apparatus according to claim 1, wherein the second printing plate is configured to print an inside of the border part of the specified image.

5. The printing apparatus according to claim 2, wherein the special ink has a same color as that of the basic ink.

6. The printing apparatus according to claim 2, wherein the functional ink is at least one of foam ink, temperature-indicating ink, photochromic ink, fluorescent ink, and varnish repellent ink.

7. The printing apparatus according to claim 2, wherein the inorganic ink is at least one of pearl pigment ink, silver ink, gold ink, and inorganic filler-containing ink.

8. The printing apparatus according to claim 1, wherein the image is a design image.

9. A printing method of printing an image on a can body, comprising:
transferring ink on a plurality of printing plates to a blanket; and
transferring the ink having been transferred on the blanket to the can body to print the image on the can body, wherein:
the plurality of printing plates include a first printing plate and a second printing plate to print a specified image of the image;
the first printing plate is configured to print a border image which is a border part of the specified image; and
the second printing plate is configured to print a vicinity of the border image in the specified image.

10. A can body on which an image is printed by a printing apparatus, the printing apparatus comprising:
a blanket transfer device configured to transfer ink on a plurality of printing plates to a blanket; and
a can body transfer device configured to transfer the ink having been transferred on the blanket to the can body to print the image on the can body, wherein:
the plurality of printing plates include a first printing plate and a second printing plate to print a specified image of the image;
the first printing plate is configured to print a border image which is a border part of the specified image; and
the second printing plate is configured to print a vicinity of the border image in the specified image.

11. The can body according to claim 10, wherein an inside image printed with an ink in any color and a bordering image printed in an ink in a same color as that of the inside image to border the inside image are formed on an outer surface of the can body.

12. The can body according to claim 11, wherein:
the ink used to print the inside image is a special ink which is at least one of a functional ink containing a functional material and an inorganic ink; and
the ink used to print the bordering image is a basic ink which is different from the special ink.

13. The can body according to claim 12, wherein:
the functional ink is at least one of foam ink, temperature-indicating ink, photochromic ink, fluorescent ink, and varnish repellent ink; and
the inorganic ink is at least one of pearl pigment ink, silver ink, gold ink, and inorganic filler-containing ink.

14. The can body according to claim 13, wherein the foam ink, the temperature-indicating ink, and the photochromic ink contain functional microcapsules as the functional material.
